(19) United States
(12) Patent Application Publication
(10) Pub. No.: US 2008/0079480 A1
(43) Pub. Date: Apr. 3, 2008

(54) Electronic device including boosting circuit

(76) Inventor: Fumiyasu Utsunomiya, Chiba-shi (JP)

Correspondence Address: BRUCE L. ADAMS, ESQ., SUITE 1231, 17 BATTERY PLACE, NEW YORK, NY, 10004, US

(21) Appl. No.: 11/904,663

(22) Filed: Sep. 27, 2007

(30) Foreign Application Priority Data
Oct. 2, 2006 (JP) 2006-270697

(51) Int. Cl. G05F 1/10

(52) U.S. Cl. 327/536

(57) ABSTRACT

Provided is an electronic device including a boosting circuit whose circuit scale-up is minimized and efficiency is high even in the case of a low power supply voltage. An NMOS transistor, whose drain and gate are connected with an input terminal and whose source is connected with a gate terminal of a charge transfer NMOS transistor in a boosting unit, is provided in parallel to an NMOS transistor for charging and discharging the gate terminal of the charge transfer NMOS transistor.

### BACKGROUND OF THE INVENTION

1. Field of the Invention

The present invention relates to an electronic device including a boosting circuit, and more particularly, to an electronic device including a boosting circuit working by the same principle as that of a Dickson charge pump boosting circuit.

2. Description of the Related Art

In recent years, a power supply voltage of an electronic device is reduced in order to realize a reduction in power consumption thereof. Accordingly, it is necessary for a boosting circuit to achieve an increase from a low voltage. For example, although an EEPROM which is a nonvolatile memory circuit requires a high voltage of approximately 18 V as a boosting voltage for memory, a power supply voltage becomes equal to or lower than 2.0 V. A boosting circuit used for the EEPROM is normally a Dickson charge pump boosting circuit. The Dickson charge pump boosting circuit requires an increase in the number of boosting stages in order to obtain high boosting efficiency, so a circuit scale becomes larger. Therefore, a further improved boosting circuit is proposed (for example, JP 07-079561 A).

FIG. 5 shows a conventional Dickson charge pump boosting circuit.

The conventional Dickson charge pump boosting circuit has a structure in which a plurality of boosting units each including an input terminal IN and an output terminal OUT, and an NMOS transistor NT0, which acts as an output-stage transistor and is diode-connected, are connected in series between a power supply terminal VIN and a boosting power output terminal VOUT.

The respective boosting units have the same structure. For example, a boosting unit CPO1 includes a charge transfer NMOS transistor NT1, an NMOS transistor NTG1 for charging and discharging a gate terminal of the NMOS transistor NT1, a boosting capacitor C1, and a capacitor CG1 for increasing a gate voltage of the NMOS transistor NT1. The boosting unit CPO1 further includes a boosting clock signal input terminal NCLK to which a boosting clock signal is input and a gate clock signal input terminal NCLKG to which a clock signal for increasing the gate voltage of the charge transfer NMOS transistor NT1 is input. A first boosting clock signal Φ1 and a second gate clock signal ΦG2 are input to the corresponding input terminals of the boosting units located in odd-numbered stages. A second boosting clock signal Φ2 and a first gate clock signal ΦG1 are input to the corresponding input terminals of the boosting units located in even-numbered stages.

FIG. 6 shows signal waveforms of the boosting clock signals and the gate clock signals. After the first boosting clock signal Φ1 is changed from a low level to a high level, the second boosting clock signal Φ2 is changed from the high level to the low level. After that, the first gate clock signal ΦG1 is changed from the low level to the high level. After the second boosting clock signal Φ2 is changed from the low level to the high level, the first boosting clock signal Φ1 is changed from the high level to the low level. After that, the second gate clock signal ΦG2 is changed from the low level to the high level. Therefore, the waveforms of the respective clock signals are formed.

In the case of such waveforms, while the gate voltage of the charge transfer NMOS transistor NT1 is made equal to a voltage at the power supply terminal VIN through the NMOS transistor NTG1, the gate voltage is raised by a clock amplitude based on the second gate clock signal ΦG2. Therefore, the gate voltage of the charge transfer NMOS transistor NT1 is completely turned on, so the boosting capacitor C1 can be efficiently charged.

However, the conventional Dickson charge pump boosting circuit requires the boosting clock signals and the gate clock signals, that is, four kinds of clock signals. Further, it is necessary to control three kinds of clock signals such that change timings of the potentials of the clock signals do not coincide with one another during a half period of a clock signal frequency.

That is, in order to surely shift the change timings of the potentials of the clock signals, it is necessary to increase the driving power of a clock buffer circuit to improve potential change speeds of the clock signals. Therefore, the clock buffer circuit whose driving power is very large is required, thereby causing an increase in circuit scale. When time periods for shifting the potential change timings of the respective boosting clock signals are shortened, it is likely that the potential change timings of the boosting clock signals coincide with one another in the case where a variation in driving powers of clock buffer circuits or a difference between power supply voltages occurs. Thus, it is difficult to increase the frequencies of the clock signals, leading to a problem in that a boosting speed and a boosting power cannot be improved.

The boosting voltage is reduced due to the drop of a forward voltage of the NMOS transistor NT0 which acts as the output-stage transistor and is diode-connected. Therefore, it is necessary to further increase the number of boosting units connected in series, so there is a problem in that the circuit scales of the boosting circuit and the clock buffer circuit further increase.

### SUMMARY OF THE INVENTION

The present invention has been made to solve the above problems. An object of the present invention is therefore, to provide an electronic device including a boosting circuit having a high boosting power without an increase in circuit scale of each of a clock buffer circuit and a boosting circuit.

According to the electronic device including the boosting circuit of the present invention, a structure is employed in which, in a Dickson charge pump boosting circuit, an NMOS transistor, whose drain and gate are connected with an input terminal and whose source is connected with a gate terminal of a charge transfer NMOS transistor of a boosting unit, is provided in parallel to an NMOS transistor for charging and discharging the gate terminal of the charge transfer NMOS transistor.

Also in the above structure, an NMOS transistor NT0 which acts as an output-stage transistor and is diode-connected is replaced by a circuit in which a boosting capacitor is omitted from the same structure as that of the boosting unit.

Further in the above structure, a depletion type NMOS transistor is used as an NMOS transistor of a boosting unit located in a subsequent stage.

As described above, the electronic device including the boosting circuit of the present invention has the following effects. Circuit scales of a clock buffer circuit and the boosting unit can be reduced, so a cost reduction can be realized. A frequency of each clock signal can be increased, so a boosting speed of the boosting circuit and a boosting power thereof can be improved.

The depletion type NMOS transistor is used as the NMOS transistor of the boosting unit located in the subsequent stage, so a W-length of each of NMOS transistors of the boosting unit located in the subsequent stage can be shortened. Therefore, a circuit area of the boosting circuit can be reduced. Because the W-length of each of NMOS transistors can be shortened, the capacitance of a load to be driven by the clock buffer circuit can be reduced. Thus, a circuit scale of the clock buffer circuit can be further reduced to realize a cost reduction.

### BRIEF DESCRIPTION OF THE DRAWINGS

In the accompanying drawings:

FIG. 1 is a circuit diagram showing an electronic device including a boosting circuit according to a first embodiment of the present invention;

FIG. 2 is a waveform diagram showing clock signals of the boosting circuit of the electronic device according to the present invention;

FIG. 3 is a circuit diagram showing a boosting unit in an electronic device including a boosting circuit according to a second embodiment of the present invention;

FIG. 4 is a circuit diagram showing an output-stage boosting unit of the boosting circuit of the electronic device according to the second embodiment of the present invention;

FIG. 5 is a circuit diagram showing a conventional electronic device including a boosting circuit; and

FIG. 6 is a waveform diagram showing clock signals of the boosting circuit of the conventional electronic device.

### DETAILED DESCRIPTION OF THE PREFERRED EMBODIMENTS

### First Embodiment

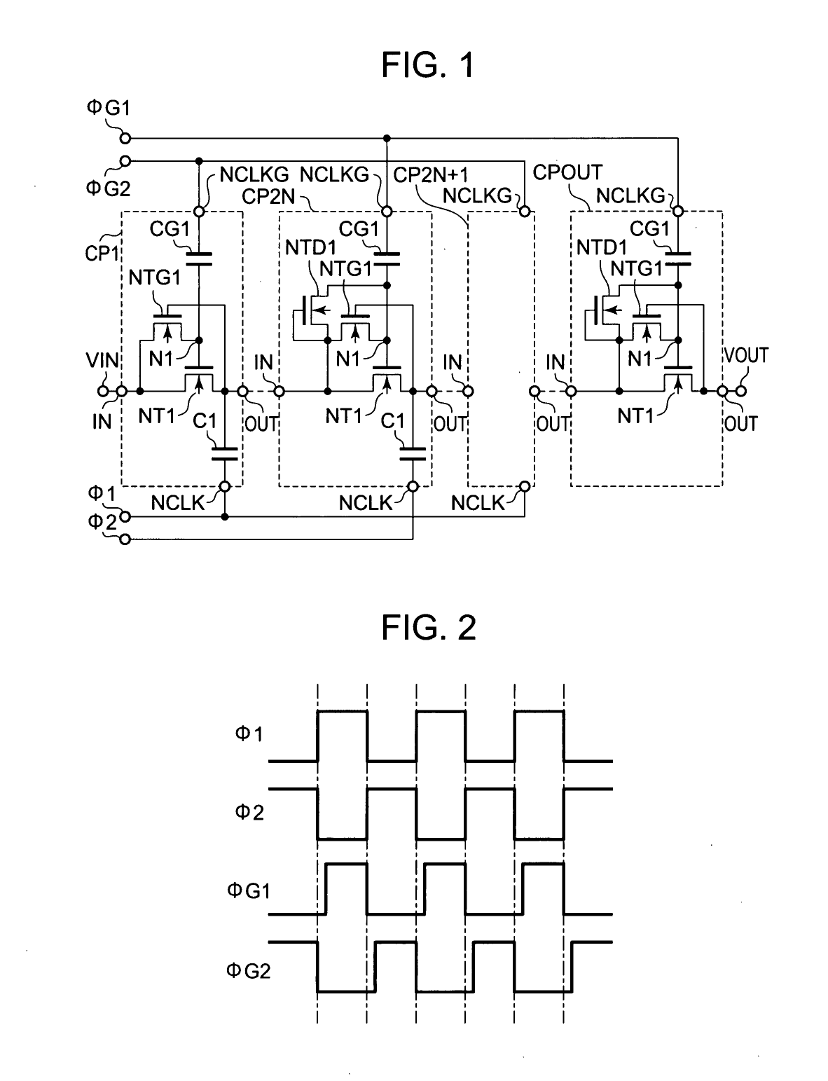

FIG. 1 is a circuit diagram showing an electronic device including a boosting circuit according to a first embodiment of the present invention.

The boosting circuit in the first embodiment includes the following structure. A plurality of boosting units CPn are connected in series between a power supply terminal VIN and a boosting power output terminal VOUT. An output-stage boosting unit CPOUT in which a boosting capacitor is omitted from the boosting unit CPn is provided in the output stage.

Each of the boosting units CPn includes a boosting clock input terminal NCLK to which a boosting clock signal is input and a gate clock input terminal NCLKG to which a gate clock signal for increasing a gate voltage of a charge transfer NMOS transistor NT1 is input. A first boosting clock signal Φ1 and a second gate clock signal ΦG2 are input to the corresponding input terminals of the boosting units located in odd-numbered stages. A second boosting clock signal Φ2 and a first gate clock signal ΦG1 are input to the corresponding input terminals of the boosting units located in even-numbered stages.

The output-stage boosting unit CPOUT includes a gate clock input terminal NCLKG to which a gate clock signal for increasing a gate voltage of a charge transfer NMOS transistor NT1 is input. The first gate clock signal ΦG1 is input to the gate clock input terminal NCLKG of the output-stage boosting unit CPOUT.

A boosting unit CP1 located in a first stage includes a charge transfer NMOS transistor NT1, an NMOS transistor NTG1 for charging and discharging a gate of the charge transfer NMOS transistor NT1, a boosting capacitor C1, and a capacitor CG1 for increasing a gate voltage of the NMOS transistor NT1. An input terminal IN, a drain of the NMOS transistor NT1, and a drain of the NMOS transistor NTG1 are connected with one another. An output terminal OUT, a source of the NMOS transistor NT1, a first electrode of the boosting capacitor C1, and a gate of the NMOS transistor NTG1 are connected with one another. The gate of the NMOS transistor NT1, a source of the NMOS transistor NTG1, and a first electrode of the capacitor CG1 are connected with one another (at a first node N1). A second electrode of the boosting capacitor C1 is connected with the boosting clock input terminal NCLK. A second electrode of the capacitor CG1 is connected with the gate clock input terminal NCLKG.

Each of the boosting units CPn located in second and subsequent stages further includes an NMOS transistor NTD1 whose drain and gate are commonly connected with the input terminal IN and whose source is connected with the gate of the NMOS transistor NT1. The NMOS transistor NTD1 is used to charge the gate of the NMOS transistor NT1.

The output-stage boosting unit CPOUT has a structure in which the boosting capacitor C1 and the boosting clock input terminal NCLK are omitted from the structure of one of the boosting units CPn located in the second and subsequent stages. The output-stage boosting unit CPOUT is used instead of the conventional NMOS transistor NT0 which is diode-connected.

In the boosting circuit having the above-mentioned structure, according to each of the boosting units CPn located in the second and subsequent stages, the gate of the NMOS transistor NT1 is maintained at a voltage equal to or larger than an input terminal voltage by the NMOS transistor NTD1. Therefore, an input voltage is increased by a gate clock voltage in response to the gate clock signal, so charges can be efficiently stored in the boosting capacitor C1 without shifting the potential reverse timings of clock waveforms unlike the conventional boosting circuit. A potential at the gate of the NMOS transistor NT1, which is increased by the gate clock voltage, is reduced to the input terminal voltage by the NMOS transistor NTG1 at the time when the potential of the boosting capacitor C1 is raised by the boosting clock signal.

Therefore, in each of the boosting units CPn which are located in the second and subsequent stages and constructed as described above, the gate of the charge transfer NMOS transistor NT1 is discharged by the NMOS transistor NTG1 and charged by the NMOS transistor NTD1. Thus, unlike the conventional boosting circuit, it is unnecessary to shift the potential reverse timings of the first boosting clock signal Φ1 and the second boosting clock signal Φ2.

FIG. 2 shows signal waveforms of the boosting clock signals and the gate clock signals in the boosting circuit according to the first embodiment.

As shown in FIG. 2, the second boosting clock signal Φ2 has a waveform obtained by reversing the first boosting clock signal Φ1. After the first boosting clock signal Φ1 is changed from a low level to a high level, the first gate clock signal ΦG1 is changed from the low level to the high level. After the second boosting clock signal Φ2 is changed from the low level to the high level, the second gate clock signal ΦG2 is changed from the low level to the high level.

As described above, the boosting circuit used for the electronic device according to the first embodiment of the present invention has the structure in which the NMOS transistor NTD1 for charging the gate of the NMOS transistor NT1 is added to the circuit structure of each of the boosting units located in the second and subsequent stages, of the boosting unit used for the conventional electronic device. Therefore, charges can be stored in the boosting capacitor C1 without shifting the potential variation timings of the first boosting clock signal Φ1 and the second boosting clock signal Φ2. That is, a clock low-level period for storing the charges is relatively longer than that in the case of the conventional boosting circuit. Therefore, the frequency of each of the clock signal can be increased, so a boosting speed of the boosting circuit and a boosting power thereof can be improved. In addition, a circuit for generating clock timings can be simplified.

Thus, although the boosting circuit used for the conventional electronic device has the problem in that the circuit scale of the clock buffer circuit becomes larger to increase the cost thereof and the boosting speed and the boosting power cannot be improved, the boosting circuit according to the first embodiment of the present invention can solve the problem.

The boosting circuit according to the first embodiment of the present invention includes the output-stage boosting unit having the above-mentioned structure. Therefore, it is possible to solve the problem in that the circuit scales of the boosting circuit and the clock buffer circuit are increased in order to compensate for a reduction in boosting voltage due to the drop of a forward voltage of the NMOS transistor which is diode-connected.

### Second Embodiment

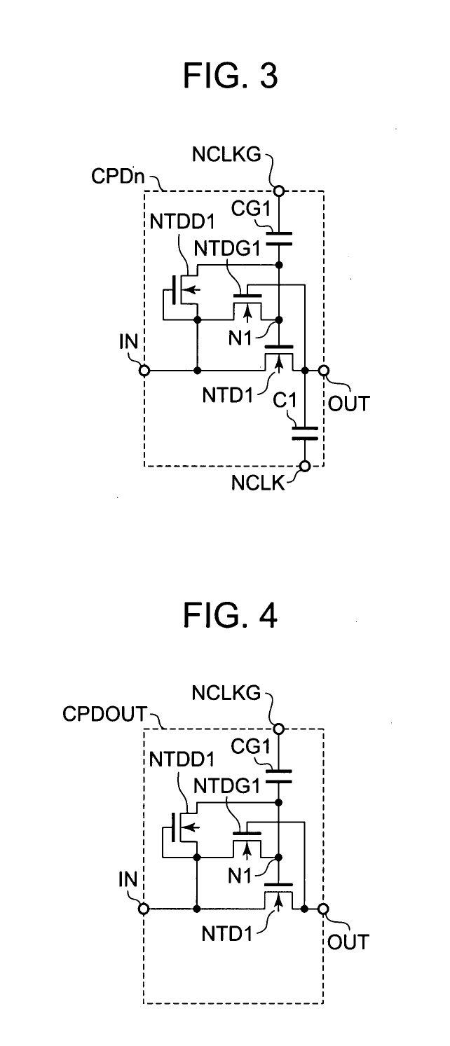

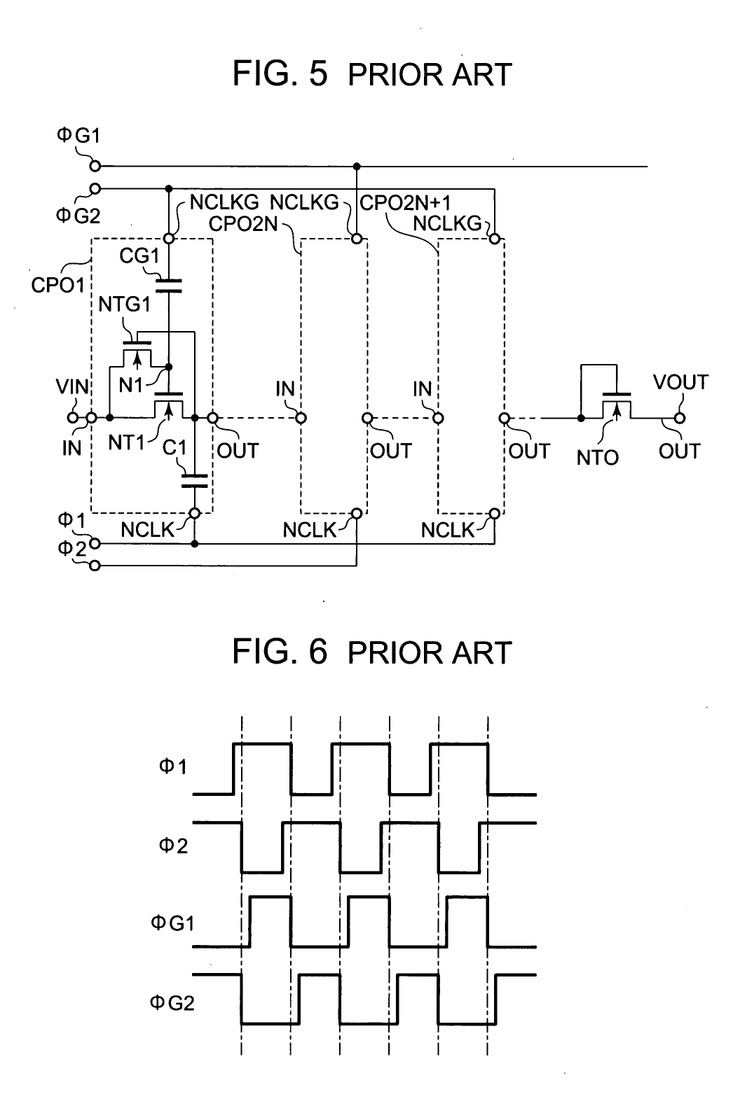

FIG. 3 is a circuit diagram showing a boosting unit CPDn in an electronic device including a boosting circuit according to a second embodiment of the present invention. As shown in FIG. 3, in the boosting unit CPDn of the boosting circuit in the second embodiment, a depletion type NMOS transistor is used as each of the NMOS transistors of the boosting unit CPn in the first embodiment 1. FIG. 4 is a circuit diagram showing an output-stage boosting unit CPDOUT of the boosting circuit in the second embodiment. As in the case of the boosting unit, the depletion type NMOS transistor is used as each of the NMOS transistors.

Although not shown, the boosting circuit in the second embodiment has substantially the same structure as that of the boosting circuit in the first embodiment. The boosting unit CPDn shown in FIG. 3 is used as a subsequent-stage boosting unit whose boosting voltage becomes higher, and the output-stage boosting unit CPDOUT shown in FIG. 4 is used for the output-stage.

According to the boosting circuit in the second embodiment which has the above-mentioned structure, even when a threshold voltage of each of the NMOS transistors in the subsequent-stage boosting unit whose boosting voltage becomes higher is increased by a back gate effect, the driving power does not reduce. Therefore, it is unnecessary to lengthen a W-length of each of the NMOS transistors, so it is possible to prevent an increase in circuit area of the boosting circuit for obtaining a high boosting voltage, which is the problem with the boosting circuit used for the conventional electronic device.

What is claimed is:

1. An electronic device, comprising a boosting circuit in which a plurality of boosting units each being a charge pump type are connected in series,
wherein each of the boosting units includes:
a boosting unit input terminal;
a boosting unit output terminal;
a boosting clock input terminal;
a first NMOS transistor for charge-transferring having a source connected with the boosting unit input terminal and a drain connected with the boosting unit output terminal;
a first capacitor for boosting having a first electrode connected with the drain of the first NMOS transistor and a second electrode connected with the boosting clock input terminal;
a gate clock signal input terminal for increasing a potential at a gate of the first NMOS transistor;
a second capacitor having a first electrode connected with the gate of the first NMOS transistor and a second electrode connected with the gate clock signal input terminal;
a second NMOS transistor having a drain connected with the boosting unit input terminal, a source connected with the gate of the first NMOS transistor, and a gate connected with the boosting unit output terminal; and
a third NMOS transistor having a drain and a gate connected with the boosting unit input terminal, and a source connected with the gate of the first NMOS transistor.

2. An electronic device according to claim 1, further comprising an output-stage boosting unit,
wherein the output-stage boosting unit includes:
an output-stage input terminal;
an output-stage output terminal;
a fourth NMOS transistor for charge-transferring having a source connected with the output-stage input terminal and a drain connected with the output-stage output terminal;
a third capacitor having a first electrode connected with a gate of the fourth NMOS transistor and a second electrode connected with the gate clock signal input terminal;
a fifth NMOS transistor having a drain connected with the output-stage input terminal, a source connected with the gate of the fourth NMOS transistor, and a gate connected with the output-stage output terminal; and
a sixth NMOS transistor having a drain and a gate connected with the output-stage input terminal, and a source connected with the gate of the fourth NMOS transistor.

3. An electronic device according to claim 1, wherein, in the boosting circuit, one of the boosting units which is provided in a subsequent stage comprises the NMOS transistors each being a depletion type.

4. An electronic device according to claim 2, wherein, in the boosting circuit, one of the boosting units which is provided in a subsequent stage comprises the NMOS transistors each being a depletion type.
